(19) United States
(12) Patent Application Publication
(10) Pub. No.: US 2025/0106806 A1
(43) Pub. Date: Mar. 27, 2025

(54) POSITION DETERMINING SYSTEM AND POSITION DETERMINING METHOD

(71) Applicant: TOYOTA JIDOSHA KABUSHIKI KAISHA, Toyota-shi (JP)

(72) Inventors: Kento IWAHORI, Nagoya-shi (JP); Noriyuki HASHIMOTO, Seto-shi (JP); Yusuke NOMURA, Kariya-shi (JP)

(73) Assignee: TOYOTA JIDOSHA KABUSHIKI KAISHA, Toyota-shi (JP)

(21) Appl. No.: 18/678,133

(22) Filed: May 30, 2024

(30) Foreign Application Priority Data
Sep. 25, 2023 (JP) 2023-159367

(51) Int. Cl. H04W 64/00; G06T 7/70

(52) U.S. Cl. CPC H04W 64/00; G06T 7/70; G06T 2207/10028

(57) ABSTRACT

The position determining system includes: a communication state acquiring unit that acquires a communication state between each of a plurality of access points and a plurality of communication devices; an placement state acquiring unit that acquires placement state data that is at least one of image data in a region in which the plurality of communication devices exist and point cloud data in the region; and a position determining unit that determines a position of the plurality of communication devices in the region by associating a relative positional relation between the plurality of communication devices estimated from the communication state with the position data of the plurality of communication devices estimated from the placement state data.

### CROSS-REFERENCE TO RELATED APPLICATION

This application claims priority to Japanese Patent Application No. 2023-159367 filed on Sep. 25, 2023, incorporated herein by reference in its entirety.

### BACKGROUND

### 1. Technical Field

The present disclosure relates to a position determining system and a position determining method.

### 2. Description of Related Art

U.S. Pat. No. 10,532,771, for example, discloses a method of determining a position of a vehicle by transmitting a request to the vehicle to execute an operation of a device provided in the vehicle, such as turning on headlights or the like, via a wireless communication network provided in a parking lot, and confirming whether the vehicle has executed the operation.

### SUMMARY

According to the related art, the vehicle has to execute some sort of action in order for the position of the vehicle to be confirmed. Accordingly, there is a problem in that processing for detecting the position of the vehicle becomes complicated. Also, there is a problem in that the position of the vehicle cannot be determined at a point in time at which the device for executing the action of the vehicle is not installed in the vehicle.

The present disclosure can be realized as the following aspect.

(1) According to one aspect of the present disclosure, a position determining system is provided. The position determining system includes
a communication state acquiring unit that acquires a communication state among each of a plurality of access points and a plurality of communication devices,
a placement state acquiring unit that acquires placement state data that is at least one of image data of a region in which the communication devices are present and point cloud data of the region, and
a position determining unit that determines positions of the communication devices in the region, by associating relative positional relations of the communication devices estimated from the communication state, with position data of the communication devices estimated from the placement state data.

According to the position determining system of this aspect, the positions of the communication devices can be determined by simple processing of using the communication state and the placement state data.

(2) In the position determining system according to the above aspect,
the communication devices may be provided in a plurality of moving bodies that is movable through the region by self driving.

The position determining unit may determine the positions of the moving bodies in the region, by associating relative positional relations of the moving bodies estimated from the communication state, with position data of the moving bodies estimated from the placement state data.

According to this position determining system, the positions of the moving bodies that are movable by self driving can be determined by simple processing that does not require actions of the moving bodies.

(3) In the position determining system according to the above aspect,
the communication state may be communication strength between the communication devices and the access points, respectively.

The position determining unit may
use a magnitude relation of the communication strength at the access points, to acquire communication strength relative positions that are relative positions of the communication devices with respect to the access points, and
associate the communication strength relative positions with the position data, so as to determine the positions of the communication devices in the region.

According to this position determining system, the position of each of the communication devices can be determined by simple processing of using the communication strength as to the access points.

(4) The position determining system according to the above aspect may further include a device information acquiring unit.

The device information acquiring unit may acquire identification information of a determination communication device that is set in advance, among the communication devices, and information regarding a determination region in which the determination communication device exists, among the regions.

The placement state acquiring unit may acquire at least one of image data of the determination region and point cloud data of the determination region as the placement state data.

The position determining unit may determine a position of the determination communication device in the determination region by associating the position of the determination communication device estimated from the communication state, with any one of position data of the communication devices including the determination communication device estimated from the placement state data.

According to this position determining system, the position of the determination communication device can be determined without determining the positions of all of the communication devices, and processing for determining a position of a determination vehicle can be simplified.

The present disclosure can be realized in various forms other than the position determining system. For example, the present disclosure can be realized in forms of a position determining device, a position determining method, a control method of the position determining device, a computer program for realizing the control method, a non-transitory recording medium storing the computer program, and so forth.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing a schematic configuration of a position determining system according to a first embodiment of the present disclosure;

FIG. 2 is a block diagram showing an internal functional configuration of the position determining device;

FIG. 3 is a flowchart showing a position determining method of a vehicle according to the first embodiment;

FIG. 4 is an explanatory diagram conceptually illustrating a communication strength relative position of a plurality of vehicles existing in a determination region;

FIG. 5 is an explanatory view conceptually showing the placement state of vehicles existing in a determination region; and

FIG. 6 is an explanatory diagram conceptually illustrating a method of determining a position of a vehicle by a position determining unit.

### DETAILED DESCRIPTION OF EMBODIMENTS

### A. In a First Embodiment

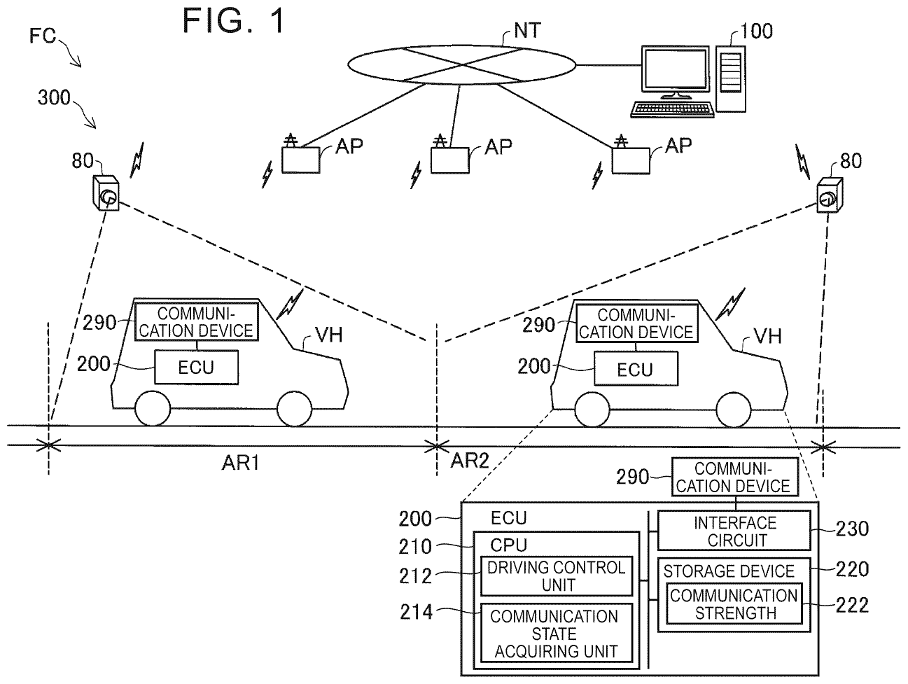

FIG. 1 is an explanatory diagram illustrating a schematic configuration of a position determining system 300 according to a first embodiment of the present disclosure. The position determining system 300 is used, for example, in a factory FC that manufactures a vehicle VH. The position determining system 300 includes a plurality of access point AP, a vehicle detector 80, a vehicle VH, and a position determining device 100. The position determining system 300 determines the relative position relation of the plurality of communication devices 290 present in the factory FC. In the present embodiment, the communication device 290 is provided in the vehicle VH, and the position determining system 300 can identify the relative positional relation of the vehicle VH by identifying the relative positional relation of the communication device 290. Hereinafter, determining the position of the vehicle VH including the communication device 290 will be described.

The access point AP communicably connects the communication device 290 and the position determining device 100 via a network NT. In each of the access point AP, identification information (hereinafter, also referred to as “access point identification information”) capable of individually identifying the access point AP, such as a service set identifier (SSID), is set.

The vehicle detector 80 is a device for measuring the placement state data. The “placement state data” is data capable of detecting the position of the vehicle VH in a predetermined region. The position of the vehicle VH is represented by, for example, the coordinates of X, Y, Z in the global coordinate system of the factory FC. Examples of the placement state data include image data of the vehicle VH and three-dimensional point cloud data of the vehicle VH. The “three-dimensional point cloud data” is data indicating the three-dimensional position of the point cloud. The placement state data may be used, for example, to estimate the position of the vehicle VH and/or the orientation of the vehicle VH. The estimated position of the vehicle VH and the direction of the vehicle VH can be used, for example, for autonomous travel of the vehicle VH by remote control.

In the present embodiment, the vehicle detector 80 is an external camera that is provided outside the vehicle VH and acquires images of a predetermined region where the vehicle VH is present. The vehicle detector 80 is communicably connected to the position determining device 100 by wireless communication or wired communication. In the embodiment of FIG. 1, a plurality of vehicle detectors 80 corresponding to each of the plurality of region AR1, AR2 in the factory FC are provided. The region AR1, AR2 is, for example, a process in a manufacturing process, a building, or the like, and is an arbitrarily divided region. The number of sections of the region is not limited to two of the region AR1, AR2, and may be one or any number of three or more. One region may be provided with one or more vehicle detectors 80. Further, in FIG. 1, each of the region AR1, AR2 may include a plurality of vehicle VH, although one vehicle VH is disposed in each of the region AR1, AR2.

Examples of the vehicle VH include passenger cars, trucks, buses, and construction vehicles. In the present embodiment, the vehicle VH is a battery electric vehicle (BEV) capable of traveling on the factory FC by self driving. “self driving” means an operation that does not depend on the operation of the passenger. self driving may be performed with or without an occupant. The occupant includes a driver who is on the vehicle VH and an occupant other than the driver who is on the vehicle VH. self driving may also include driving by automatic and manual remote control using a device provided outside the moving body. In the present embodiment, the vehicle VH can receive a control command transmitted from a remote control device (not shown) or the like connected to the network NT via the communication device 290 and automatically travel in accordance with the control command. However, the present disclosure is not limited thereto, and the vehicle VH may include a vehicle that is manually driven by the driver's maneuver.

Vehicle identification information is set in each of the vehicle VH. The “vehicle identification information” means various types of information that can individually identify the vehicle VH. The vehicle identification information includes, for example, vehicle identification number (VIN) ID information given for each vehicle VH, and a serial number of a vehicle VH used for production control.

The vehicle VH includes a communication device 290 and an ECU 200. ECU 200 performs various controls of the vehicle VH. ECU 200 includes a storage device 220 such as a hard disk drive (HDD), solid state drive (SSD), an optical recording medium, and a semiconductor memory, a CPU 210 as a central processor, and an interface-circuit 230. CPU 210, the storage device 220, and the interface circuit 230 are bi-directionally communicably coupled via an internal bus. The interface circuit 230 is connected to a communication device 290, an actuator (not shown), and the like.

The communication device 290 wirelessly communicates with a device, such as the position determining device 100, external to the vehicle VH connected to the network NT via the access point AP. In each of the communication devices 290, identification information (hereinafter, also referred to as “communication device identification information”) capable of individually identifying the communication device 290 is set. The communication device identification information is, for example, an IP address or a MAC address allocated to each communication device 290.

The storage device 220 stores a computer program for realizing at least a part of the functions provided in the present embodiment. By CPU 210 executing various computer programs stored in the storage device 220, functions such as the driving control unit 212 and the communication state acquiring unit 214 are realized.

The driving control unit 212 executes driving control of the vehicle VH. The “driving control” is various controls for driving an actuator group that performs the functions of “running”, “bending”, and “stopping” of the vehicle VH, such as adjusting the acceleration/speed and the steering angle. The actuator group includes, for example, an actuator of a driving device for accelerating the vehicle VH, an actuator of a braking device for decelerating the vehicle VH, and an actuator of a steering device for changing the traveling direction of the vehicle VH. When the driver is on the vehicle VH, the driving control unit 212 can cause the vehicle VH to travel by controlling the actuator group in accordance with the driver's manipulation. In addition, the driving control unit 212 may control the actuator group in accordance with the control command transmitted from the position determining device 100 regardless of whether or not the driver is on the vehicle VH, thereby causing the vehicle VH to travel by self driving.

The communication state acquiring unit 214 acquires the communication state between the communication device 290 and each of the plurality of access point AP. The communication state is a parameter related to communication between the communication device 290 and the access point AP, and is a parameter that can vary depending on the relative position of the communication device 290 with respect to the access point AP. In the present embodiment, the communication state acquiring unit 214 acquires, as the communication state, the communication strength (units: dBm) between the communication device 290 and the access point AP for each access point AP. The communication strength may also be referred to as a radio wave strength or a signal strength. In the present embodiment, when the communication strength is high, it is estimated that the distance to the target access point AP is shorter than when the communication strength is low. The acquired communication strength is stored in the storage device 220 as the communication strength 222 in a state of being associated with the access point identification information. The communication state acquiring unit 214 may acquire, as the communication state, a response-time in communication between the access point AP and the communication device 290 instead of the communication strength. For example, the communication state acquiring unit 214 may acquire, as the communication state, a response time from when a ping command or the like is transmitted from the access point AP to the communication device 290 or from the communication device 290 to the access point AP until when a response is received.

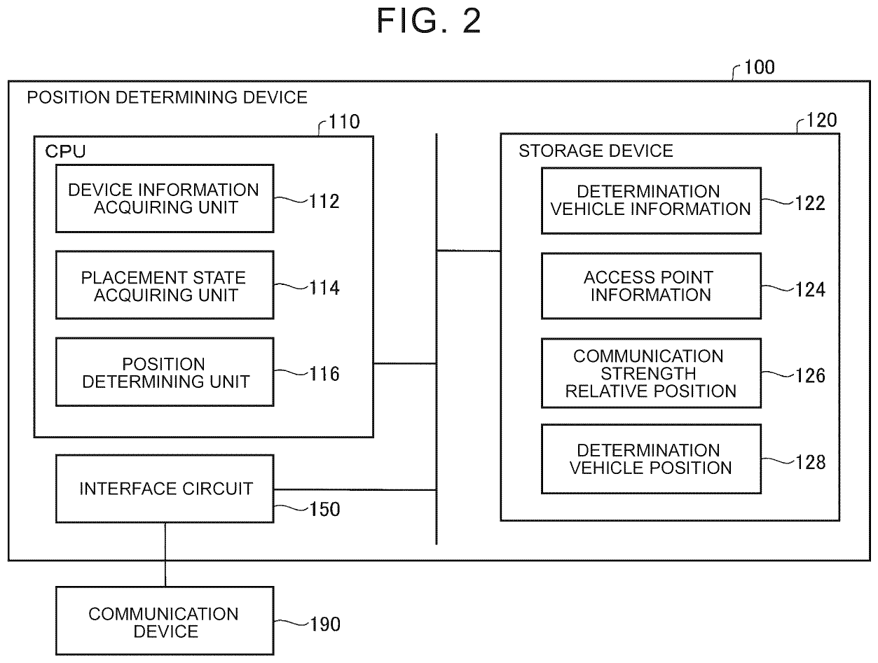

FIG. 2 is a block diagram illustrating an internal functional configuration of the position determining device 100. The position determining device 100 determines positions of a plurality of vehicles VH in a predetermined region. In the present embodiment, the position determining device 100 determines the position of the vehicle VH by using the communication strength 222 and the placement state data obtained from the vehicle detector 80. “determining the position of the vehicle VH” means associating the vehicle identification information with the position of the vehicle VH having the vehicle identification information. A predetermined vehicle VH for determining a position is also referred to as a “determination vehicle”. The communication device 290 determined in advance as a target for determining the position is also referred to as a “determination communication device”. In the exemplary embodiment of FIG. 1, the position determining device 100 is provided outside the vehicle VH, but may be mounted on the vehicle VH.

The position determining device 100 includes a CPU 110 as a central processing unit, a storage device 120, an interface-circuit 150, and a position determining communication device 190. CPU 110, the storage device 120, and the interface circuit 150 are bi-directionally communicably coupled via an internal bus. The interface circuit 150 is connected to the position determining communication device 190. The position determining communication device 190 communicates with a vehicle VH, a predetermined data base, or the like via a network NT.

The storage device 120 is, for example, a RAM, ROM, HDD, a SSD, or the like. The readable/writable region of the storage device 120 stores vehicle information 122, access point information 124, a communication strength relative position 126, and a determination vehicle position 128. Further, the storage device 120 stores a computer program for realizing at least a part of the functions provided in the present embodiment. When the computer program stored in the storage device 120 is executed by CPU 110, CPU 110 functions as the device information acquiring unit 112, the placement state acquiring unit 114, and the position determining unit 116. However, some or all of these functions may be configured by a hardware circuit.

The device information acquiring unit 112 acquires the vehicle information 122. The device information acquiring unit 112 can acquire the vehicle information 122 from, for example, a production managing device that manages the production of the vehicle VH, a data base stored in a predetermined server, or the like. The vehicle information 122 is information regarding the vehicle identification information of the vehicle VH, the communication device identification information of the communication device 290, and a region where the vehicle VH exists. The vehicle information 122 includes vehicle identification information of a determination vehicle, communication device identification information of a determination communication device provided in the determination vehicle, and determination vehicle information that is information about a region where the determination vehicle exists (hereinafter, also referred to as a “determination region”). The device information acquiring unit 112 can also execute ping confirmation by transmitting a ping command to the communication device 290 to perform response confirmation.

The device information acquiring unit 112 further acquires the access point information 124 from the access point AP. The access point information 124 includes access point identification information set in each of the access point AP, information related to the position of the access point AP, and the like. The position of the access point AP is represented, for example, by the coordinates of X, Y, Z in the global coordinate system of the factory FC. The access point information 124 may include a correlative relation between a communication strength with the access point AP and a distance from the access point AP.

The placement state acquiring unit 114 acquires the placement state data from the vehicle detector 80, and acquires the position data of the vehicle VH included in the placement state data. For example, when the placement state data is image data, the placement state acquiring unit 114 can acquire the position of the vehicle VH included in the image data. The position of the vehicle VH can be acquired, for example, by calculating the coordinates of the positioning point of the vehicle VH in the image coordinate system using the outline of the vehicle VH detected from the image data, and converting the calculated coordinates into the coordinates in the global coordinate system.

The outline of VH of vehicles included in the image data can be detected, for example, by inputting a captured image into a detection model that utilizes artificial intelligence. Examples of the detection model include a learned machine learning model learned to realize either semantic segmentation or instance segmentation. As the machine learning model, for example, a convolutional neural network (hereinafter, CNN) learned by supervised learning using a learning dataset can be used. The training data set includes, for example, a plurality of training images including vehicle VH, and correct answer labels indicating which of the regions in the training images indicates the vehicle VH and the regions other than the vehicle VH. When CNN is learned, the parameters of CNN are preferably updated by back propagation so as to reduce the error between the output and the correct label.

The position determining unit 116 acquires the communication strength relative position 126 and the determination vehicle position 128, and determines the position of the vehicle VH using the acquired communication strength relative position 126 and the determination vehicle position 128. The communication strength relative position 126 is a relative position of the plurality of communication devices 290 with respect to the plurality of access point AP. As will be described later, the communication strength relative position 126 is estimated from the magnitude relation of the communication strength between the plurality of access point AP. The determination vehicle position 128 is the position of the determination vehicle determined by the position determining unit 116. The determination vehicle position 128 is used, for example, for determining a position of a vehicle VH when autonomous travel of a determination vehicle is started by remote control. In place of the communication strength, when the response time in communication between the access point AP and the communication device 290 is acquired, instead of the magnitude relation of the communication strength, the relation of the length of the response time may be used.

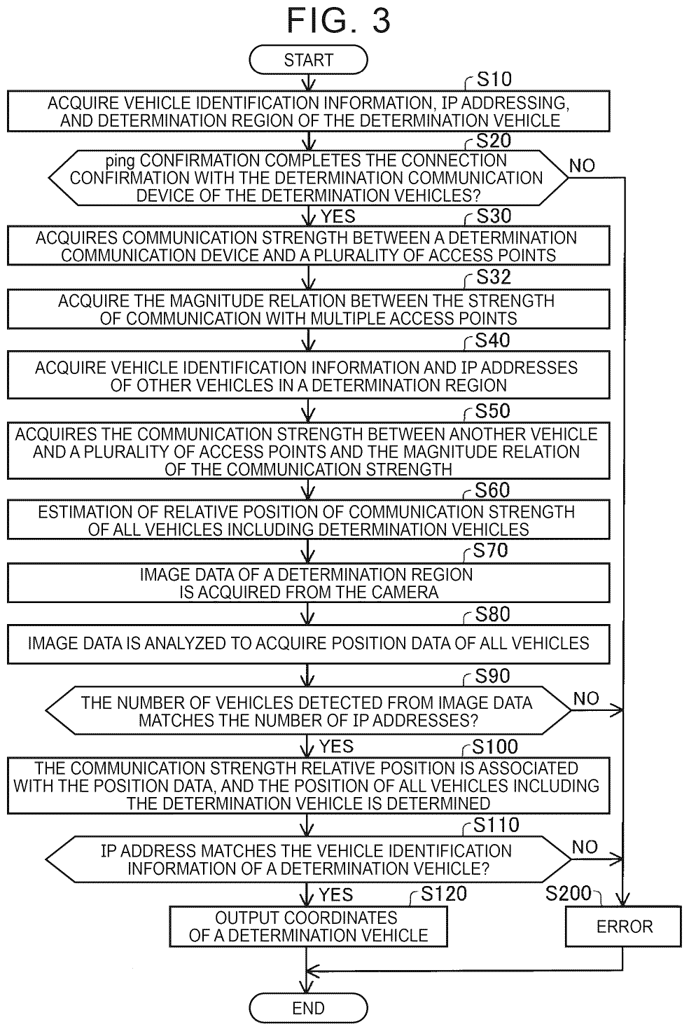

FIG. 3 is a flow chart illustrating a position determining method of the vehicle VH according to the first embodiment. This flow is started by the start of automatic traveling of a determination vehicle by remote control or the like.

In S10, the device information acquiring unit 112 acquires the determination vehicle information from a production-management device, a data base, or the like. Specifically, the device information acquiring unit 112 acquires, as the determination vehicle information, the vehicle identification information of the vehicle VH to be automatically traveled by remote control, IP addressed to the communication device 290 provided in the vehicle VH, and the region of the factory FC where the vehicle VH exists.

In S20, the device information acquiring unit 112 performs ping checking on the determination communication device included in the determination vehicle. Specifically, the device information acquiring unit 112 transmits a ping command to IP address acquired as the determination vehicle information and performs response confirmation, thereby executing connection confirmation of the radio communication with the determination communication device. If the connection cannot be confirmed, retry may be performed a predetermined number of times. If no connectivity is confirmed (S20: NO), the process proceeds to S200. In S200, the device information acquiring unit 112 notifies an error, and ends this process. When the connection is confirmed (S20: YES), the process proceeds to S30. Note that S20 may be omitted when the connection is not confirmed.

In S30, the device information acquiring unit 112 acquires the communication strength 222 stored in the storage device 220 of the determination vehicle, that is, the communication strength between the determination communication device and the plurality of access point AP. The number of access point AP for acquiring the communication strength is preferably 3 or more from the viewpoint of improving the estimation accuracy of the communication strength relative position. Instead of acquiring the stored communication strength 222, the device information acquiring unit 112 may transmit a command for causing the device information acquiring unit 112 to acquire the communication strength to the communication state acquiring unit 214 of the determination vehicle, and acquire the latest communication strength acquired by the communication state acquiring unit 214.

In S32, the device information acquiring unit 112 uses the acquired communication strength 222 to acquire the magnitude relation of the communication strength 222 between the plurality of access point AP. Specifically, the device information acquiring unit 112 sorts the access point identification information so that the communication strengths are in a strong order. As described above, in the present embodiment, when the communication strength is high, it is estimated that the distance to the access point AP is shorter than when the communication strength is low. Therefore, it can be said that the access point identification information is sorted so that the distances are in a short order. In place of the communication strength, when the response time in communication between the access point AP and the communication device 290 is acquired, instead of the magnitude relation of the communication strength, the relation of the long and short response time may be used. When the response time is long, it can be estimated that the distance from the access point AP to the communication device 290 is longer than when the response time is short.

In S40, S50, the device information acquiring unit 112 executes the same process as S32 from the above-described S10 on the other vehicle VH. In S40, the device information acquiring unit 112 determines a vehicle VH (hereinafter, also referred to as “other vehicle VH”) other than the determination vehicle existing in the determination region from a data base or the like, and acquires the vehicle information 122 of the determined other vehicle VH. Specifically, the device information acquiring unit 112 acquires the vehicle identification information of the other vehicle VH and IP address set in the communication device 290 included in the other vehicle VH. In the present embodiment, VH of other vehicles is 2. Note that the device information acquiring unit 112 may further perform ping checking on all other vehicle VH.

In S50, the device information acquiring unit 112 acquires the communication strength 222 stored in the storage device 220 of the other vehicle VH, that is, the communication strength between the other vehicle VH and the plurality of access point AP. Note that the access point AP to which the communication strength is to be acquired is preferably the same as the access point AP from which the communication strength with the determination vehicle indicated by S30 is acquired, from the viewpoint of facilitating the distinction between the determination vehicle and the other vehicle VH. In addition, when a plurality of other vehicle VH exist in the determination region, it is preferable to acquire the communication strength 222 from all other vehicle VH from the viewpoint of facilitating the distinction between the determination vehicle and the other vehicle VH.

The device information acquiring unit 112 uses the acquired communication strength 222 to confirm the magnitude relation of the communication strength 222 between the plurality of access point AP for each of the other vehicles VH. Specifically, the device information acquiring unit 112 sorts the access point identification information so that the order of the communication strengths is strong. In S60, the position determining unit 116 estimates the communication strength-relative position of each of all vehicle VH including the determination vehicle and the other vehicle VH.

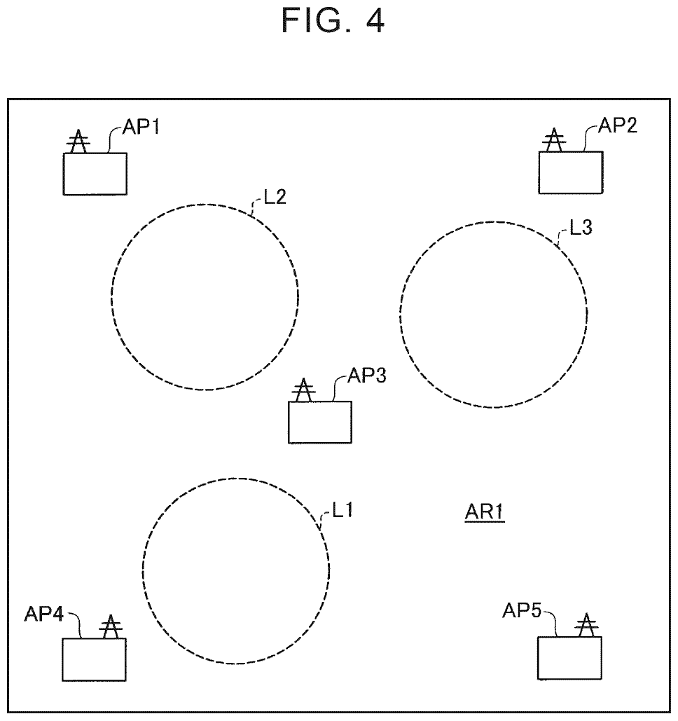

FIG. 4 is an explanatory diagram conceptually illustrating a communication strength-relative position of a plurality of vehicles VH existing in a determination region AR1. FIG. 4 schematically illustrates a plurality of access point AP1, AP2, AP3, AP4, AP5 including a determination region AR1 in a communication area, and communication strength-relative position L1, L2, L3 of three vehicles VH including a determination vehicle and another vehicle VH. In FIG. 4, the communication strength relative position L1, L2, L3 is conceptually illustrated using a circle centered on coordinates estimated from the magnitude relation of the communication strength 222 and having a radius of an arbitrarily determined error. Hereinafter, the access point identification information of the access point AP1, AP2, AP3, AP4, AP5 will be described as “AP1, AP2, AP3, AP4, AP5”.

In the example of FIG. 4, an example will be described in which, when the determination vehicle VH1 and the other vehicle VH2, VH3 are used, the magnitude relations of the respective communication strengths of the access point AP1, AP2, AP3, AP4, AP5 for the respective vehicles are sorted as follows.
Magnitude relation between Communication Strength of determination vehicle VH1=AP4>AP3>AP5>AP1>AP2
Magnitude relation between Communication Strength of Other Vehicle VH2=AP1>AP3>AP2=AP4>AP5
Magnitude relation between Communication Strength of Other Vehicle VH3=AP2>AP3>AP5>AP1>AP4

In the present embodiment, the magnitude relation between the communication strengths of the vehicle VH is estimated as the magnitude relation between the vehicle VH and the respective access point AP. Therefore, the communication strength relative position of a determination vehicle derived from the magnitude relation of the communication strength can be estimated as a position L1 that is closest to the access point AP4, next closer to the access point AP3, then closer to the access point AP5, then closer to the access point AP1, and the access point AP2 is farthest among the position L1, L2, L3. From the viewpoint of improving the estimation accuracy of the communication strength relative position, the coordinate value in the determination region AR1 may be calculated by converting the value of the communication strength into the distance instead of or together with the magnitude relation of the communication strength. In addition, whether to use the magnitude relation of the communication strength or the coordinate value in the determination region AR1 may be selectively switched according to the number of VH of vehicles to be estimated. When VH of vehicles to be estimated is large, it is possible to accurately distinguish the vehicle VH by using the coordinates in the determination region AR1.

The communication strength relative position of the other vehicle VH2 is closest to the access point AP1 and then to the access point AP3 and then to the access point AP2, AP4 of the position L1, L2, L3, and is equidistant from the access point AP2, AP4, and the access point AP5 can be estimated to be the farthest position L2. The relative position of the communication strength of the other vehicle VH3 can be estimated as the remaining position L3. Alternatively, the communication strength relative position of the other vehicle VH3 may be estimated as being closest to the access point AP2, next closer to the access point AP3, then closer to the access point AP5, then closer to the access point AP1, and the access point AP4 being the farthest position L3.

Returning to FIG. 3, in S70, the placement state acquiring unit 114 acquires the image data of the determination region AR1 as the placement state data from the external camera as the vehicle detector 80. In S80, the position determining unit 116 acquires the position data of the vehicle VH included in the image data. Specifically, the position determining unit 116 calculates the coordinates of the vehicle VH in the global coordinate system of the determination region AR1 by inputting the acquired image data into the learned machine learning model.

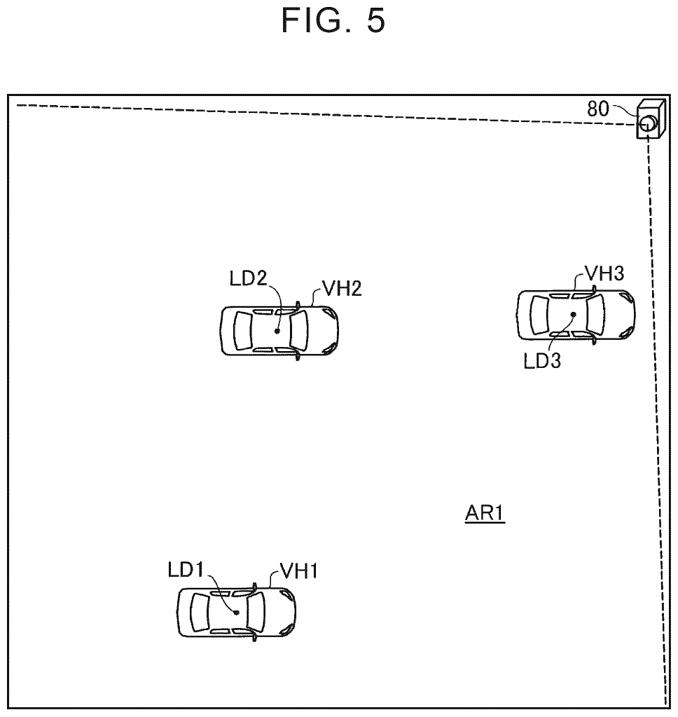

FIG. 5 is an explanatory diagram conceptually illustrating a placement state of the vehicle VH existing in the determination region AR1. The placement state acquiring unit 114 acquires the image data of the determination region AR1 including the three vehicles VH1, VH2, VH3 from the vehicle detector 80. The placement state acquiring unit 114 acquires the coordinate LD1, LD2, LD3 of the vehicle VH1, VH2, VH3 in the global coordinate system of the determination region AR1 as the position data by inputting the image data into the machine learning model. The placement state acquiring unit 114 does not acquire the correspondence relation between the three vehicles VH and the vehicle identification information of the respective vehicle VH.

Returning to FIG. 3, in S90, the placement state acquiring unit 114 confirms whether or not the number of vehicle VH acquired from the image data matches the total number of IP addresses acquired by S10 and S40. It is checked whether or not the number of vehicle VH detected from the image data of the determination region AR1 matches the number obtained by integrating “1” corresponding to IP address of the determination vehicle with the number of IP addresses of the other vehicle VH acquired by S40. If the numbers of VH of vehicles do not match (S90: NO), the placement state acquiring unit 114 shifts the process to S200 and ends the process.

In the present embodiment, the number of vehicle VH is 3, which corresponds to the number of IP addresses of the other vehicle VH, 2, and the number obtained by integrating 1, which is IP address of the determination vehicle. When the numbers of VH of vehicles coincide with each other (S90: YES), the placement state acquiring unit 114 shifts the process to S100. In S100, the position determining unit 116 determines the positions of all the vehicle VH including the determination vehicle and the other vehicle VH by associating the acquired communication strength relative positions with the position data acquired from the image data.

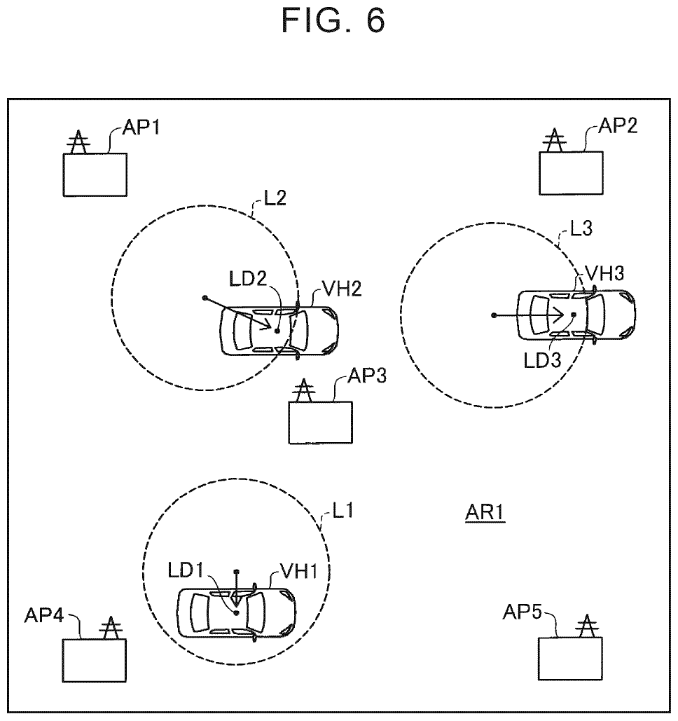

FIG. 6 is an explanatory diagram conceptually illustrating how the position determining unit 116 determines the position of the vehicle VH. In FIG. 6, the communication strength relative position L1, L2, L3 illustrated in FIG. 4 and the respective coordinates of the determination vehicle VH1 and the other vehicle VH2, VH3 illustrated in FIG. 5 are illustrated using the global coordinate system of the determination region AR1. The position determining unit 116 associates the communication strength relative position L1, L2, L3 and the coordinate LD1, LD2, LD3 acquired from the image data with each other, and determines that IP address corresponding to the communication strength relative position L1, L2, L3 or the vehicle VH having the vehicle identification information is arranged in the coordinate LD1, LD2, LD3.

For example, the position determining unit 116 associates the communication strength relative position L1, L2, L3 with the coordinate LD1, LD2, LD3 of the vehicle VH within a predetermined distance from the communication strength relative position L1, L2, L3. In the present embodiment, an error range set in the communication strength relative position is used as the predetermined distance. The position determining unit 116 associates the communication strength relative position L1, L2, L3 with the coordinate LD1, LD2, LD3 included in the error range of the communication strength relative position L1, L2, L3 with each other. Note that the position determining unit 116 may associate the communication strength relative position with the coordinates closest to the communication strength relative position with each other.

The position determining unit 116 estimates that the vehicle VH including the communication device 290 having IP address corresponding to the communication strength relative position L1, L2, L3 is arranged in the coordinate LD1, LD2, LD3 of the vehicle VH. In the example of FIG. 6, since the coordinate LD1 is included in the error range of the communication strength relative position L1 corresponding to the vehicle identification information of the determination vehicle, the position determining unit 116 can determine that the vehicle VH1 located in the coordinate LD1 is the determination vehicle by associating the communication strength relative position L1 and the coordinate LD1 with each other. Note that the vehicle VH2, VH3 positioned at the coordinate LD2, LD3 can also be determined in the same manner as the determination vehicle.

Returning to FIG. 3, in S110, the position determining unit 116 acquires the vehicle identification information from the vehicle VH identified as the determination vehicle by S100, and confirms whether or not the acquired vehicle identification information matches the vehicle identification information of the determination vehicle acquired by S10. As a method of acquiring the vehicle identification information from the vehicle VH, for example, a method of acquiring the vehicle identification information from a radio frequency-identification (RF-ID) tag attached to the vehicle VH via short-range radio communication or the like is exemplified. The vehicle identification information may be acquired by reading a two-dimensional code attached to the vehicle VH with a camera or the like. It should be noted that it may be checked whether or not IP address of the communication device 290 included in the determined vehicle VH matches IP address of the determination communication device of the determination vehicle acquired by S10. If the vehicle-identification information does not coincide (S110: NO), the position determining unit 116 proceeds to S200 and ends the process. When the vehicle-identification information matches (S120: YES), the position determining unit 116 shifts the process to S120. In S120, the coordinates of the determination vehicle are outputted to a remote control device that executes the autonomous travel of the determination vehicle, and the process ends.

As described above, the position determining system 300 of the present embodiment includes the communication state acquiring unit 214 that acquires the communication state between each of the plurality of access point AP and the plurality of communication devices 290, the placement state acquiring unit 114 that acquires the image data of the region AR1 in which the plurality of communication devices 290 exist, and the position determining unit 116 that determines the position of the plurality of communication devices 290 in the region AR1 by associating the relative positional relations of the plurality of communication devices 290 estimated from the communication state with the position data of the plurality of communication devices 290 estimated from the image data. According to the position determining system 300 of this embodiment, the position of the vehicle VH can be determined by a simple process that does not require the vehicle VH to operate by using the communication state between each of the plurality of access point AP and the plurality of communication devices 290 and the position data of the vehicle VH estimated from the image data. Further, in the case of a vehicle VH provided with the communication device 290, the position of the vehicle VH can be determined even at a time point when a device for causing the vehicle VH to execute an operation, such as a vehicle VH being manufactured, is not mounted.

According to the position determining system 300 of the present embodiment, the communication device 290 is provided in a vehicle VH that is movable in the region AR1 by self driving. The position determining unit 116 determines the position L1 of the plurality of vehicle VH in the region AR1 by associating the relative positional relations of the plurality of vehicle VH estimated from the communication state with the position data of the plurality of vehicle VH estimated from the placement state data. Therefore, the position of the vehicle VH that can be driven by the self driving can be determined by a simple process that does not require the vehicle VH to operate.

According to the position determining system 300 of the present embodiment, the communication strength between the plurality of communication devices 290 and each of the plurality of access point AP is used as the communication state. The position determining unit 116 acquires the communication strength relative position 126 which is the relative position of the plurality of communication devices 290 with respect to the plurality of access point AP by using the magnitude relation of the communication strength in the plurality of access point AP, and determines the positions of the plurality of communication devices 290 in the region AR1 by associating the communication strength relative position 126 with the position data. The position of each of the plurality of communication devices 290 can be determined by a simple process of using the communication strength with the access point AP.

The position determining system 300 of the present embodiment further includes a device information acquiring unit 112, and the device information acquiring unit 112 acquires identification information of the determination communication device and information on the determination region AR1. The placement state acquiring unit 114 acquires image data of the determination region AR1 as the placement state data. The position determining unit 116 determines the position L1 of the determination communication device in the determination region AR1 by associating any one of the position data of the plurality of vehicle VH including the determination communication device estimated from the image data of the determination region AR1 with the position L1 of the determination communication device estimated from the communication state. Since the position of the determination communication device among the plurality of communication devices can be determined without determining the positions of all the communication devices 290, the processing for determining the position of the determination vehicle can be simplified.

### B. Other Embodiments

(B1) In the above embodiment, the vehicle detector 80 is a camera that acquires images of the vehicle VH. On the other hand, the vehicle detector 80 may be a light detection and ranging (LiDAR) which is a distance measuring device instead of or together with the camera. LiDAR may measure three-dimensional point cloud data of the vehicle VH. By using LiDAR, highly accurate three-dimensional point cloud data can be acquired. In this case, the placement state acquiring unit 114 estimates the position of the vehicle VH in the acquired three-dimensional point cloud data using the three-dimensional point cloud data measured by the vehicle detector 80 as the placement state data. Specifically, the placement state acquiring unit 114 performs template matching on the three-dimensional point cloud data using the vehicle point cloud data stored in advance in the storage device 120. Therefore, the position and the direction of the vehicle VH in the three-dimensional point cloud data can be estimated with high accuracy. For example, three-dimensional CAD data of the vehicle VH can be used as the template vehicle point cloud data. The vehicle point cloud data includes information for determining the direction of the vehicle VH. For example, an iterative closest point (ICP) algorithm, a normal distribution transform (NDT) algorithm, or the like can be used for template matching of the vehicle point cloud data with respect to the three-dimensional point cloud data. When the position of the vehicle VH can be estimated with high accuracy from the three-dimensional point cloud data, the template matching may not be executed.

(B2) In the above embodiment, the position of the vehicle VH including the communication device 290 is determined. On the other hand, when the communication device 290 is not provided in an object such as a vehicle VH, the position of the communication device 290 may be determined. In this case, instead of the vehicle VH, placement state data such as image data of the communication device 290 and three-dimensional point cloud data is acquired by an external camera, a LiDAR, or the like, and the position of the communication device 290 is determined by a process similar to the process for determining the position of the vehicle VH.

The present disclosure is not limited to each of the above embodiments, and can be realized by various configurations without departing from the spirit thereof. For example, the technical features in the embodiments corresponding to the technical features in the respective embodiments described in the Summary can be appropriately replaced or combined in order to solve some or all of the above-described problems or to achieve some or all of the above-described effects. Further, when the technical features are not described as essential in the present specification, these can be deleted as appropriate.

What is claimed is:

1. A position determining system comprising:
a communication state acquiring unit that acquires a communication state among each of a plurality of access points and a plurality of communication devices;
a placement state acquiring unit that acquires placement state data that is at least one of image data of a region in which the communication devices are present and point cloud data of the region; and
a position determining unit that determines positions of the communication devices in the region, by associating relative positional relations of the communication devices estimated from the communication state, with position data of the communication devices estimated from the placement state data.

2. The position determining system according to claim 1, wherein:
the communication devices are provided in a plurality of moving bodies that is movable through the region by self driving; and
the position determining unit determines the positions of the moving bodies in the region, by associating relative positional relations of the moving bodies estimated from the communication state, with position data of the moving bodies estimated from the placement state data.

3. The position determining system according to claim 1, wherein:
the communication state is communication strength between the communication devices and the access points, respectively; and
the position determining unit
uses a magnitude relation of the communication strength at the access points, to acquire communication strength relative positions that are relative positions of the communication devices with respect to the access points, and
associates the communication strength relative positions with the position data, so as to determine the positions of the communication devices in the region.

4. The position determining system according to claim 1, further comprising a device information acquiring unit, wherein:
the device information acquiring unit acquires identification information of a determination communication device that is set in advance, among the communication devices, and information regarding a determination region in which the determination communication device exists, among the regions;
the placement state acquiring unit acquires at least one of image data of the determination region and point cloud data of the determination region as the placement state data; and
the position determining unit determines a position of the determination communication device in the determination region by associating the position of the determination communication device estimated from the communication state, with any one of position data of the communication devices including the determination communication device estimated from the placement state data.

5. A position determining method comprising:
acquiring a communication state among each of a plurality of access points and a plurality of communication devices;
acquiring placement state data that is at least one of image data of a region in which the communication devices are present and point cloud data of the region; and
determining positions of the communication devices in the region, by associating relative positional relations of the communication devices estimated from the communication state, with position data of the communication devices estimated from the placement state data that is acquired.
